(19) United States
(12) Patent Application Publication
(10) Pub. No.: US 2004/0138904 A1
(43) Pub. Date: Jul. 15, 2004

(54) Dynamic human resources knowledge base and process

(76) Inventor: Teresa L. La Loggia, Chicago, IL (US)

Correspondence Address: DICKSTEIN SHAPIRO MORIN & OSHINSKY LLP, 2101 L STREET NW, WASHINGTON, DC, 20037-1526, US

(21) Appl. No.: 10/429,046

(22) Filed: May 5, 2003

Related U.S. Application Data
(60) Provisional application No. 60/377,249, filed on May 3, 2002.

(51) Int. Cl. G06F 17/60

(52) U.S. Cl. 705/1

(57) ABSTRACT

The present invention provides a method for administering a human resources policy. The present invention further provides a system for administering a human resources policy.

This application claims priority from Provisional Application No. 60/377,249, filed May 3, 2002.

### FIELD OF THE INVENTION

This invention relates generally to providing legal services and more particularly to providing comprehensive, up-to-date, and easily accessible legal analysis via a computer network.

### DISCUSSION OF THE RELATED ART

Both attorney and non-attorney corporate professionals are frequently confronted with questions that require some level of legal analysis. For example, in the field of Human Resources (“HR”) decision-makers are in a highly regulated field (including mid-level managers, HR professionals, and legal professionals) and must frequently must determine answers to questions that are impacted by various non-national and national statutes, court rulings and other legal sources. In the case of large companies with thousands of employees, HR decision-makers are often required to continually provide answers to questions that arise time and again in similar or identical form. These questions most often fall into three categories: (1) questions about the company's policy; (2) questions about the relevant law on the issue; and (3) questions about how to proceed in a matter while fulfilling the requirements of the company's policy and relevant law.

Until now, HR decision-makers seeking to answer questions about company policy have been faced with a confusing and complex collection of HR policy materials. They must wade through voluminous materials—employee handbooks, policy manuals, procedural guidelines and other management memoranda to locate the particular policy applicable to the situation at hand.

Typically, corporate HR policy materials are scattered in a variety of formats and locations. As a result, company compliance, legal and HR decision-makers are hard-pressed to locate and update material when policy initiatives are implemented or when regulations require modifications to policy materials. Often, out-of-date and noncompliant materials remain available in hard copy format or on the corporate intranet. Additionally, HR decision-makers face difficulties in determining where to look for relevant information and in finding the most current version of information. Furthermore, rank-and-file employees, heretofore unable to determine answers to their inquiries without communicating with managers, HR professionals and even legal professionals, have not had access to a quick and accurate answer to even the most mundane HR questions.

The above situation creates both operational inefficiencies and significant liability risk: a policy that is difficult to locate is difficult to enforce and will provide little protection in any HR-related litigation. Likewise, obsolete or inconsistent policy statements open the company to claims of noncompliance with current law and inconsistent policy administration—a touchstone of discrimination litigation.

Similarly, employees and HR decision-makers seeking to determine the relevant law on an issue currently have access to a wide variety of HR materials. Multiple HR and legal companies currently provide newsletters, handbooks, reference manuals and many different types of web-based resources. Company HR decision-makers who need to find an answer to a particular question typically must sort through a plethora of print and web-based materials to find both the right source of information for their particular issue, and then again to find the “answer” to the specific question that has arisen in the course of managing the company's HR operations.

Additionally, when enterprise-wide issues arise, companies must spend precious capital on HR-based multi-state surveys conducted by a professional services firm, which must then be translated into “real world” language and communicated to the company's employees. The company then must identify, locate and modify all HR communications which are impacted by the results of the surveys. Significantly, because regulations governing HR-related issues are constantly changing, these expensive multi-state surveys and resulting modifications of HR materials are frequently rendered obsolete almost immediately upon delivery. In short, multi-state legal surveys are very expensive in both time and money, yet provide very little return for the company.

Finally, even where the company's policy and the relevant law have been determined, HR decision-makers are confronted with the question of how to apply the policy and required legal provisions.

In attempting to resolve these HR problems, companies have turned to the Internet to enhance distribution of HR-related materials. Ironically, employees in companies who have been leaders in implementing intranets face even more difficult challenges. What began as an innovative transformation from paper to the Web has become a liability as companies find it virtually impossible to control all HR policy materials that have been cobbled together by various internal groups on their website and in hard copy. Content provided to rank-and-file employees is typically located on one site, while management and HR professional content is provided on another site, and legal resources provided to in-house counsel through yet another site. All too often, companies respond to this crisis by creating even more documentation to guide employees through the labyrinth of materials. In short, employees now face an amalgam of internally inconsistent, redundant and hard-to-find policies.

In addition, there exist a number of web sites, subscription services and the like, which provide guidance and tools for HR decision-makers. Likewise, multiple websites provide legal information, including such information specific to HR issues. As with corporate intranets, these existing services and websites frequently contain too much information. The information is also poorly organized and not suitable for obtaining all relevant resources for a particular HR question. HR decision-makers must thereby navigate a patchwork of print and web materials, none of which is complete, to cover all HR issues specific to the company. Even then, these services or websites provide only information of a general nature and not tailored to a company's policies and procedures.

No existing service or website is also useful for all classes of HR decision-makers, managers, HR professionals, and lawyers. Legal information is incomprehensible to HR personnel seeking concrete answers to a specific policy question, while HR information does not include adequate legal analysis or is updated too infrequently. Therefore, companies must rely upon multiple sources to obtain comprehensive resources to each relevant audience. Finally, typical websites and services generally provide no way to “capture” results related to a particular issue for future use by other employees. The end result is that at best, the company ends up with yet one more non-integrated source of materials that must be reviewed.

In short, many services exist to provide relevant and potentially helpful content. However, no single source provides comprehensive coverage that is specifically tailored to the company's policies, locations, structure and HR organization.

What is needed is a new service for providing comprehensive HR analysis that does not suffer the many shortcomings of known services and websites.

### BRIEF SUMMARY OF THE INVENTION

The present invention enables companies to communicate, manage and administer their HR policies in a clear, consistent, compliant, current and cost-effective manner by (a) customizing organization and content according to the company's specific HR policies and organization; (b) organizing and delivering HR content through the web to ensure that an inquiring HR decision-maker and even a rank-and-file employee has access to accurate and current information in a convenient format, and (c) constantly monitoring applicable state and federal law and, where necessary to comply with changing regulations, updating company content.

One preferred embodiment of the present invention called HR PolicyPartner™ incorporates all HR-related into a single unified source, including (a) company-specific HR policies; (b) company-specific HR procedures; (c) company-specific HR forms; (d) company-specific HR management guidance; (e) company-specific HR communications; (f) links to company-specific HR operational/transactional applications; (g) general HR and legal resources; and (h) links to government and other HR-employment law guidance sites, which can be seamlessly integrated into the company's existing internet or network structure.

HR PolicyPartner™ also delivers all HR content in a format native to the company's specific structure and organization: Content is organized and delivered on a state-by-state basis, so that content delivered to a particular employee is specific to the state where that particular employee is located. Content is organized and delivered based on company-specific policy and HR organization so that all content related to a specific policy/issue is directly linked (i.e., one-click away) to all other content related to that issue, and so that all content is categorized consistently with company-specific terminology and organization. In addition, content is organized and delivered based on employee classification, so that content delivered to a particular employee is specific to both the state where that particular employee is located, and also the employee's classification (e.g., “rank-and-file”, manager, HR professional, legal, etc.).

Where appropriate, multiple-levels of content are organized and delivered within a single page (rather than via direct links). Content organized in this manner enables employees with managerial or HR oversight responsibilities to view the content communicated to employees at a lower organizational level. This increases consistency in understanding and application of the company's HR policies by ensuring that with each successive supervisory level, the employee can know what has been communicated to employees under his/her supervision.

Finally, where appropriate, content is organized and delivered based on company-specific organization. In other words, if the company maintains separate policy material depending on business unit, the content, which is already organized and delivered on a state-specific, content-type specific and employee classification-specific basis, is further delivered on a business unit-specific basis.

In the HR PolicyPartner™ embodiment of the present invention, content may be monitored on an ongoing basis to ensure ongoing compliance. All company-specific HR content is audited to ensure compliance with all applicable regulations prior to inclusion in HR PolicyPartner™. When regulatory changes or new case law requires a modification to any of the HR PolicyPartner™ content, all affected content (e.g., policy, procedures, forms, legal summaries) may be updated to reflect these changes.

In short, HR PolicyPartner™ reduces time incurred maintaining various forms of policy materials, increases consistency in HR policy administration and implementation, streamlines cooperation between in-house legal and HR departments, leverages investment in research subject across all affected operations, reduces outside counsel's learning curve when a policy issue arises, reduces risk of legal liabilities arising from noncompliance, reduces risk of liability arising from inconsistent policy administration, reduces the cost of defense when litigation does occur, and increases employee satisfaction through consistent messaging and application of HR policies.

HR PolicyPartner™ may also provide advanced automated monitoring of company HR policy management and administration. Actions of HR decision-makers and rank-and-file employees may be monitored, analyzed and reported. Employee certification and acknowledgement processes may also be automated.

Additional advantages and features of the present invention will be apparent from the following detailed description provided in connection with the accompanying drawings which illustrate exemplary embodiments of the invention.

### BRIEF DESCRIPTION OF THE DRAWINGS

FIG. 1 is a flowchart representing the steps in a method of the present invention;

FIG. 2 is a diagram illustrating the relationship between various elements of the present invention;

FIG. 3 is a diagram illustrating the relationship between various elements of the present invention;

FIG. 4 is a diagram illustrating the relationship between various elements of the present invention;

FIG. 5 is a diagram illustrating the relationship between various elements of the present invention;

FIG. 6 is a diagram illustrating the relationship between various elements of the present invention;

FIG. 7 is a flowchart showing selected steps in a method of the present invention;

FIG. 8 is a graphical representation of a feature of the present invention;

FIG. 9 is a flowchart showing selected steps in a method of the present invention;

FIG. 10 is a flowchart showing selected steps in a method of the present invention;

FIG. 11 is a possible architectural design for a system of the present invention;

FIG. 12 is a flowchart representing the function of a component of a system of the present invention;

FIG. 13 is a flowchart representing the function of a component of a system of the present invention;

FIG. 14 is a screen capture of a computer program which embodies the present invention;

FIG. 15 is a screen capture of a computer program which embodies the present invention;

FIG. 16 is a screen capture of a computer program which embodies the present invention;

FIG. 17 is a screen capture of a computer program which embodies the present invention;

FIG. 18 is a screen capture of a computer program which embodies the present invention;

FIG. 19 is a screen capture of a computer program which embodies the present invention;

FIG. 20 is a screen capture of a computer program which embodies the present invention;

FIG. 21 is a screen capture of a computer program which embodies the present invention;

FIG. 22 is a screen capture of a computer program which embodies the present invention;

FIG. 23 is a screen capture of a computer program which embodies the present invention.

### DETAILED DESCRIPTION OF THE INVENTION

In the following description, reference is made to the accompanying drawings which will serve to illustrate exemplary embodiments of the invention. The description provides sufficient detail to enable those skilled in the art to practice the invention. Of course other embodiments may be used and various changes may be made without departing from the scope of the present invention. The scope of this invention is defined by the appended claims.

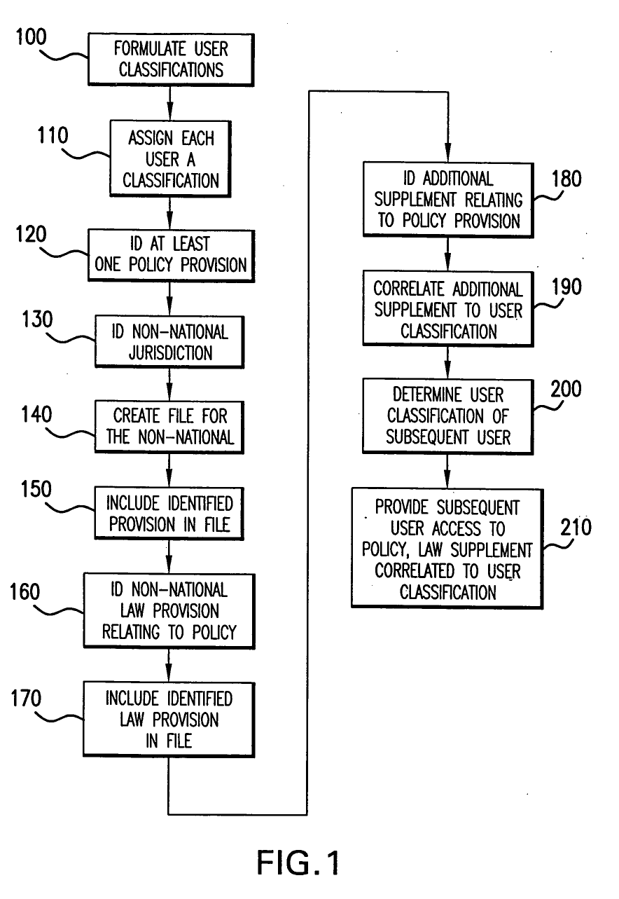

The preferred embodiment of the present invention is represented as the method illustrated in FIG. 1. At step 100, a plurality of user classifications are formulated. These classifications represent a user's position within the company. Typical classifications in this application would be rank-and-file employee, manager, HR professional, and legal counsel. Based on these positions, potential users are assigned the appropriate user classification at step 110. At step 120, the process of compiling a comprehensive policy file begins where the provisions of the policy are identified. At step 130, possible non-national jurisdictions are identified. A non-national jurisdiction may be any political unit that, with other like political units, are contained in a national political unit. Examples include states in the United States and provinces in Canada. At step 140, a file is created for at least one non-national jurisdiction, and preferably at least each of the non-national jurisdictions where the policy is in force. At step 150, the identified policy provision is included in at least one non-national file, and preferably in all non-national files. At step 160, at least one non-national law provision relating to the identified and included policy provision is identified. This related non-national law provision is included in its corresponding non-national file at step 170. More preferably, every non-national law provision relating to the policy provision is identified and included in its corresponding non-national jurisdictional file at step 170.

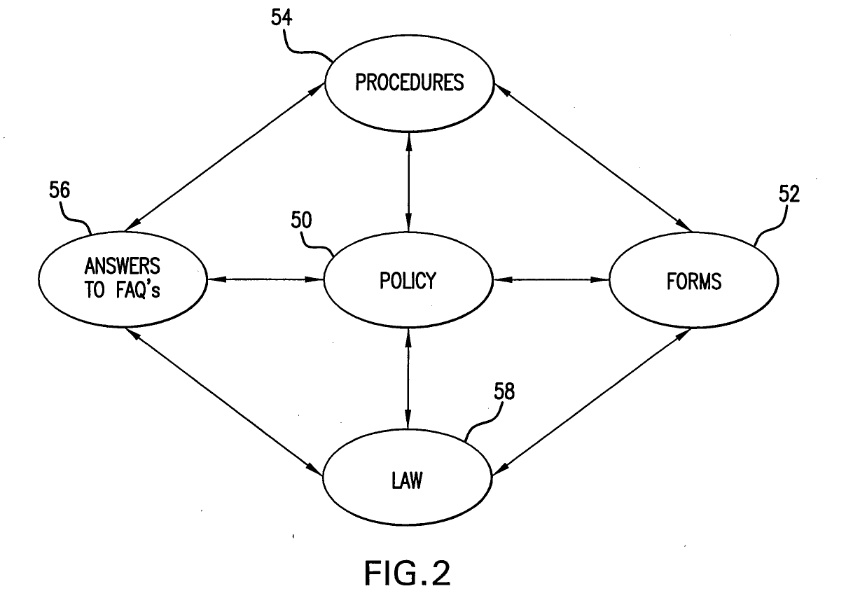

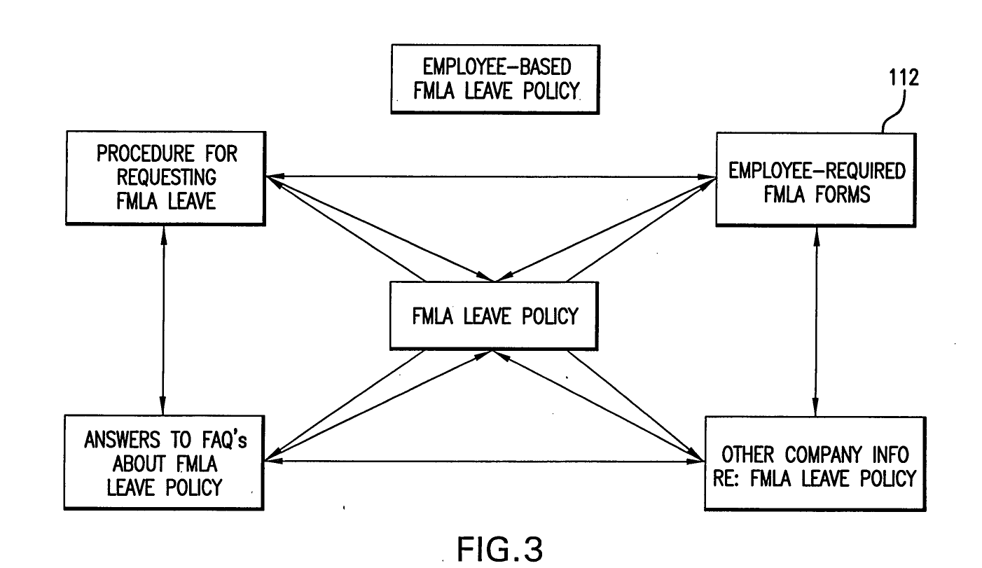

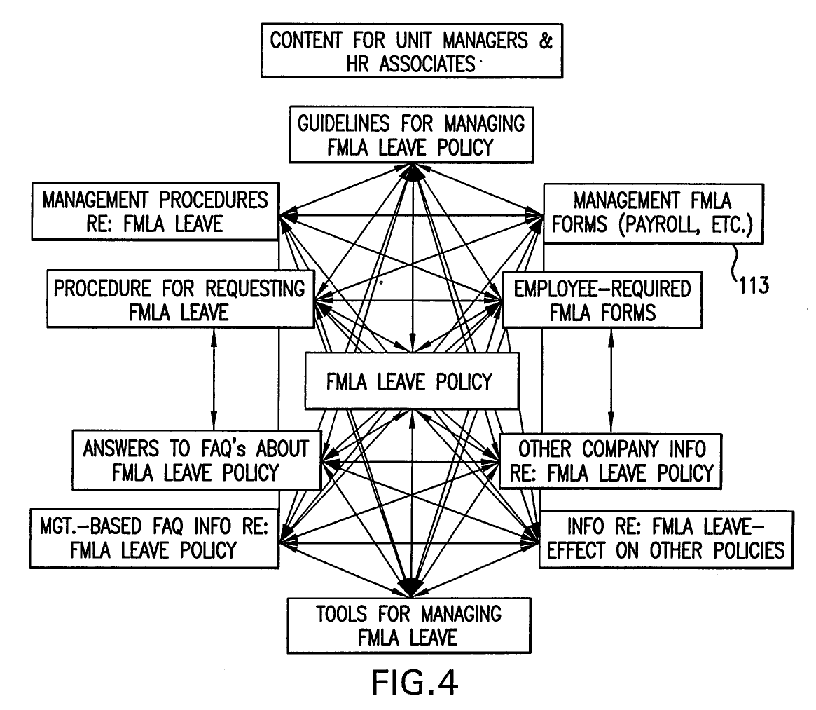

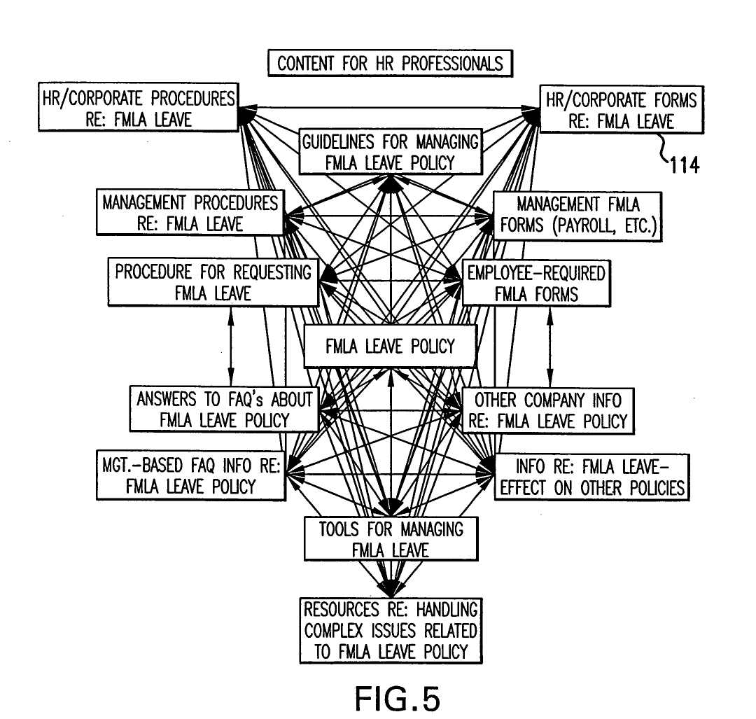

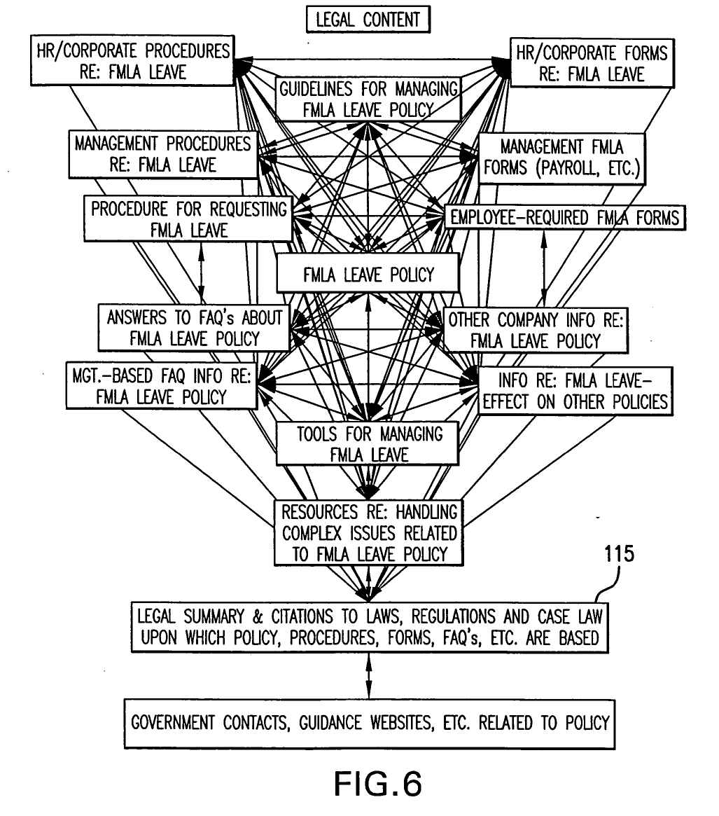

At step 180, at least one additional supplement relating to the policy provision is identified. Examples of such supplements are shown in FIG. 2 and include, but are not limited to, such supplements as forms 52, procedures 54 and answers to frequently asked questions (FAQs) 56. Examples of other possible additional supplements are shown in FIGS. 3-6 (see, e.g., FIG. 3, Employee-required FMLA forms 112; FIG. 6, Legal summary & citations 115). At step 190, any identified additional supplement is correlated to a user classification. At step 200, the user classification of a subsequent user is determined and at step 210, the user is provided access to the policy provision, the non-national law provision, and, based on the user's user classification, at least one additional supplement. Providing selective access enables users to view the proper depth and kind of additional supplements they need. For example, it would be helpful for legal counsel to have access to the text and legal citation of a non-national law provision, while employees and HR professionals may find the citation superfluous.

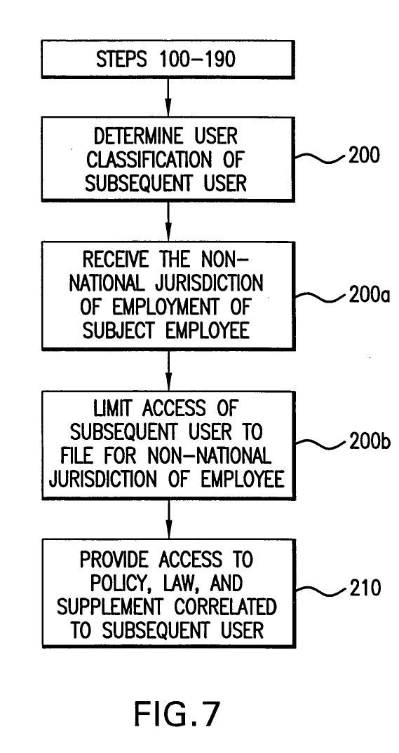

The preferred embodiment of the present invention also limits the information to which a user is provided access based on the geographic location of employment of a subject employee. Referring to FIG. 7, step 200 appears the same as step 200 from FIG. 1. In this embodiment, however, step 200a of receiving the non-national jurisdiction of employment of a subject employee occurs after step 200. Using the non-national jurisdiction of employment of the subject employee, access of the subsequent user is limited at step 200b to the file for the non-national jurisdiction matching the subject employee's jurisdiction of employment. This allows the subsequent user to view only information relevant to the subject employee without having to filter laws and supplements from unrelated non-national jurisdictions. At step 210, the subsequent user is provided access to a non-national jurisdiction specific policy provision; the non-national jurisdiction specific law provisions, and the non-national jurisdiction specific additional supplement correlated to the user's classification.

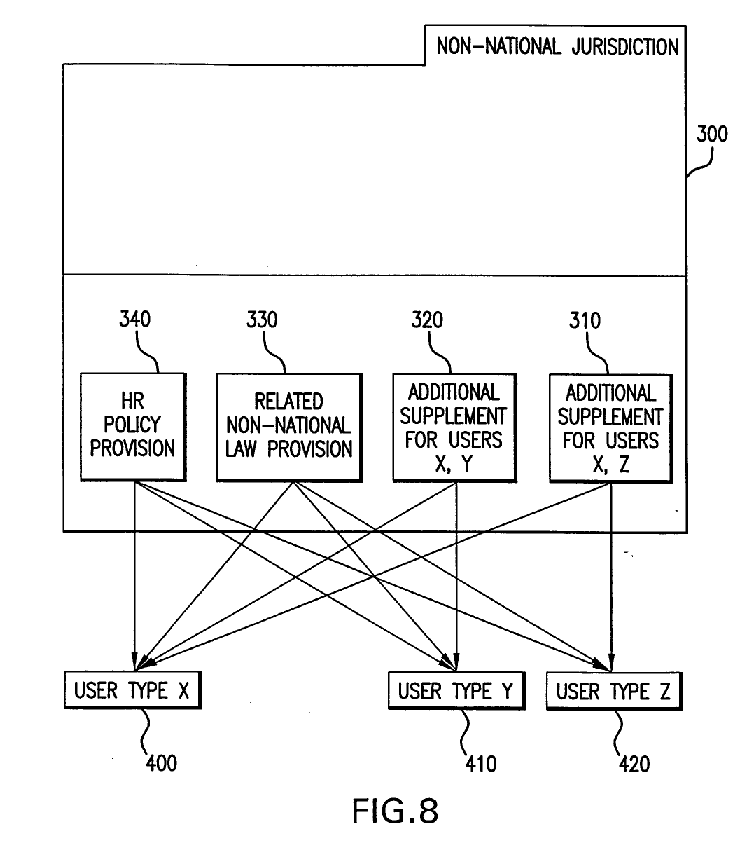

FIG. 8 provides a graphical representation of how additional supplements are correlated to user classifications and retrieved and provided accordingly. Non-national jurisdictional specific file 300 includes policy provision 340, law provision 330, an additional supplement 320 correlated to users of user classifications X and Y and an additional supplement 310 correlated to users of user classifications X and Z. As shown in FIG. 8, while users with classifications X, Y, and Z are all provided access to policy provision 340 and law provision 330, access to additional supplements 320 and 310 depends on correlation to user classifications. Only a user with classification X 400 and a user with classification Y 410 are provided access to additional supplement 320, while a user with classification X 400 and a user with classification Z 420 are provided access to additional supplement 310.

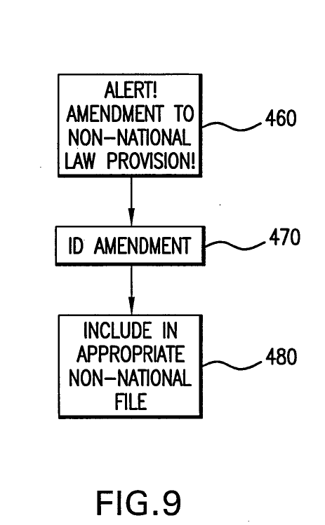

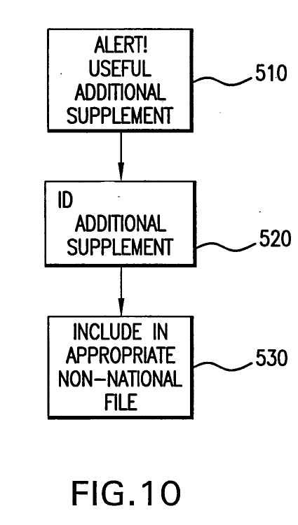

The preferred embodiment of the present invention may be updated according to amendments to identified law provisions or the identification of new additional supplements. Referring to FIG. 9, a non-national law provision is monitored at step 460 after being included in the appropriate file. At step 470 the amendment is identified and at step 480 it is included in the appropriate non-national file. An amendment may be a change to the relevant statutory law, or a significant court interpretation that must be considered when analyzing the law provision included in the file. FIG. 10 shows a similar process for updating additional supplements included in a file. At step 510 a new related additional supplement is monitored. At step 520 the new additional supplement is identified and at step 530, it is included in the proper non-national file.

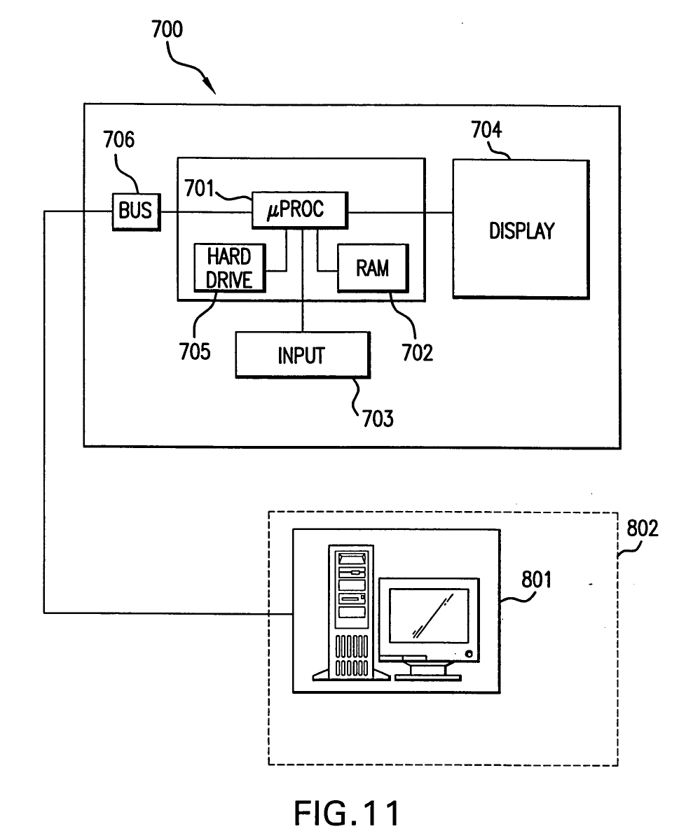

Another preferred embodiment of the present invention is a computer system for administering an HR policy. This embodiment is described herein in terms of the hardware, procedures and routines, and end-user functionality. One possible hardware configuration is shown in FIG. 11. Included in this embodiment of system 700 is a processor 701, memory such as a RAM 702, an input unit 703, a display unit 704, hard drive 705, and a bus for communicating with other systems 706. Other possible configurations for system 700 will be apparent to one of ordinary skill in the art. Bus 706 provides communication between system 700 and system 801 from which a user accesses the system subsequent to the establishment of system 700. System 801 is optionally a remote system included as part of remote server 802. System 700 may, for example, be located on the premises of a party such as a law firm establishing system 700, or may be located at the premises of a contractor or other third party. Optionally remote server 802 may, for example, be located at the premises of a client of a party establishing system 700.

Referring still to FIG. 11, system 700 includes a storing means such as hard drive 705. One of ordinary skill in the art will recognize that any suitable known storing means may be used in place of hard drive 705. Storing means such as hard drive 705 stores a plurality of defined user classifications as discussed above; a HR policy provision; a non-national law provision relating to said policy provision; and at least one additional supplement relating to said policy provision and correlated to at least one of the stored user classifications.

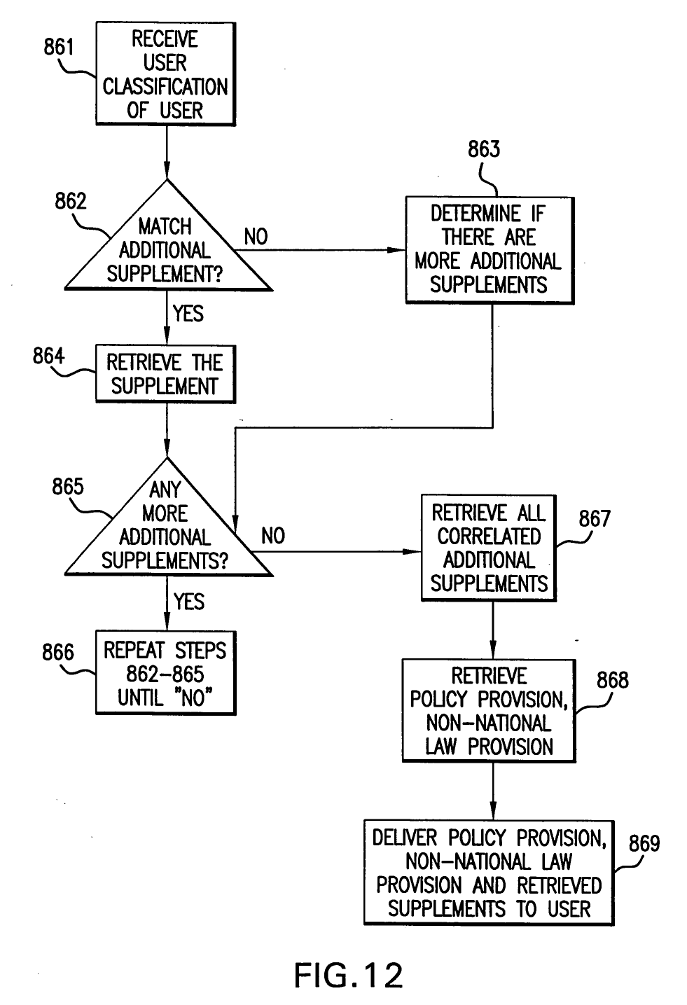

System 700 also includes a determining means for determining the user classification of a subsequent user. This is shown in FIG. 12 at step 861. The user classification may be received from the user directly, or may be received from the storing means based on a prior assignment of a user classification to user's unique name or user ID. As also shown in FIG. 12, system 700 further comprises a retrieval means for retrieving an additional supplement correlated to the user's user classification. At step 862 the retrieving means attempts to match the user classification received in step 861 with at least one additional supplement previously correlated to that user classification. If the retrieving means determines a match at step 862, it retrieves the matching supplement at step 864. The retrieving means then proceeds to step 865 to determine whether there are any more additional supplements to be matched. Likewise, if at step 862, the retrieving means determines that the user classification does not match the first compared supplement, it is forwarded at step 863 to step 865. If at step 865 the retrieving means determines that there is at least one more additional supplement to be compared, it repeats (at step 866) steps 862-865 until the determination at step 865 is negative. When the determination at step 865 is negative, the retrieving means retrieves all the additional supplements that correlate to the user classification at step 867. The retrieval then retrieves the relevant policy provision and non-national law provision at step 868. At step 869, the delivery means delivers to the user the policy provision, the non-national law provision, and the retrieved additional supplements.

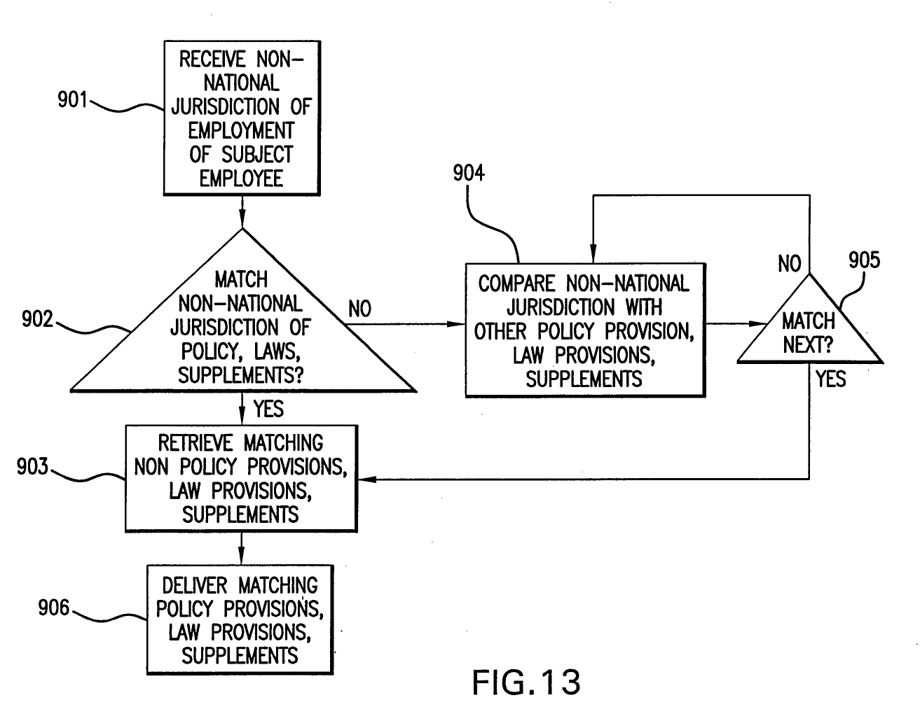

The preferred embodiment of the present invention also includes receiving means for receiving the non-national jurisdiction of employment of the subject employee and limiting means for limiting access of the user to the information relevant to the non-national jurisdiction of employment of the subject employee. This is represented in FIG. 13. At step 901 the receiving means receives the non-national jurisdiction of employment of the subject employee. As described above, the jurisdiction may be received in response to the user entering the jurisdiction, or it may be determined based on the subject employee's unique identifier, such as name or employee ID. At step 902, the limiting means attempts to match the received non-national jurisdiction with the jurisdiction a non-national law provision and an associated additional supplement stored in the storing means. If there is no match, limiting means proceeds to step 904 where it attempts to match the received non-national jurisdiction of employment of the subject employee with the next non-national law provision and associated additional supplement. If it is determined at step 905 that there is still no match, steps 904 and 905 are repeated until a match is determined. When a match is determined, whether at step 902 or step 905, the limiting system retrieves the matching non-national law provision, additional supplement and policy provision at step 903 and delivers them to the user at step 906.

The above and additional features of system 700 may be best appreciated by considering the functionality of one preferred embodiment, HR PolicyPartner™. HR PolicyPartner is a secure web-based service that allows various HR decision-makers and even rank-and-file employees to access corporate policy provisions, related law provisions and additional related supplements.

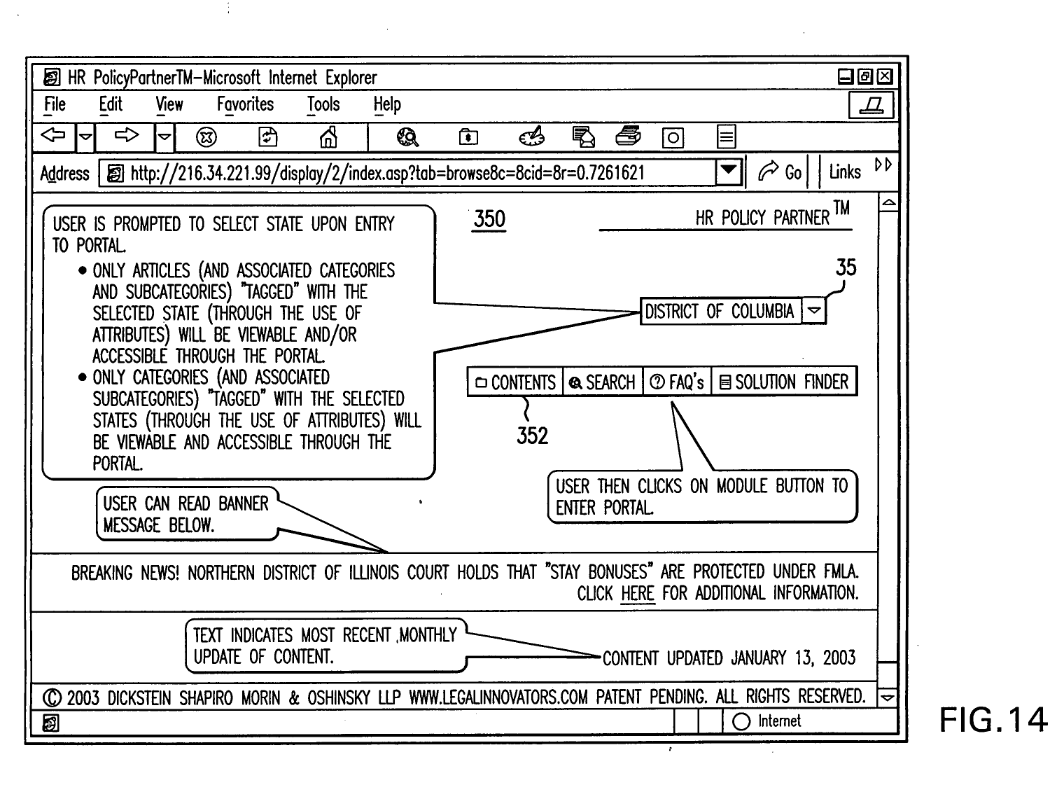

As mentioned above, the present invention provides information categories by non-national jurisdictions, so that only the information applicable to the given subject employee is provided to the user. Content provided regarding an employee working in the company's California location is California-specific, while content provided relating to an employee working in the company's Wisconsin location is Wisconsin-specific. For example, referring to FIG. 14, the HR PolicyPartner™ home page can require the employee to select his/her given non-national jurisdiction in the non-national jurisdiction menu 351 on page 350. Content delivery is based on the employee's selection in menu 351. Where the user is a person other than the person for whom the inquiry is being made, the user enters a subject employee's location in menu 351, and not necessarily his or her own location. Alternatively, as also discussed above, the subject employee's location can be derived from a unique employee identifier such as employee name or employee ID. This eliminates the requirement for a user to make a non-national jurisdiction selection in menu 351. HR PolicyPartner™ also enables HR professionals and legal employees, who typically are responsible for multiple jurisdictions, to select a new non-national jurisdiction while in the HR PolicyPartner™. In other words, in pages subsequent to page 350, the user need not re-enter the portal in order to retrieve content applicable to a different non-national jurisdiction. The employee merely selects the desired non-national jurisdiction from menu 351, which is available from the HR PolicyPartner™ contents window 352. Upon this selection, all content delivered is specific to the selected non-national jurisdiction.

Additionally, the non-national content may be fully integrated with the national and company-wide content. In other words, the content provided to the California employee includes all enterprise-wide information except where California law (or company policy) requires California-specific information, and for those specific issues, the content is California specific.

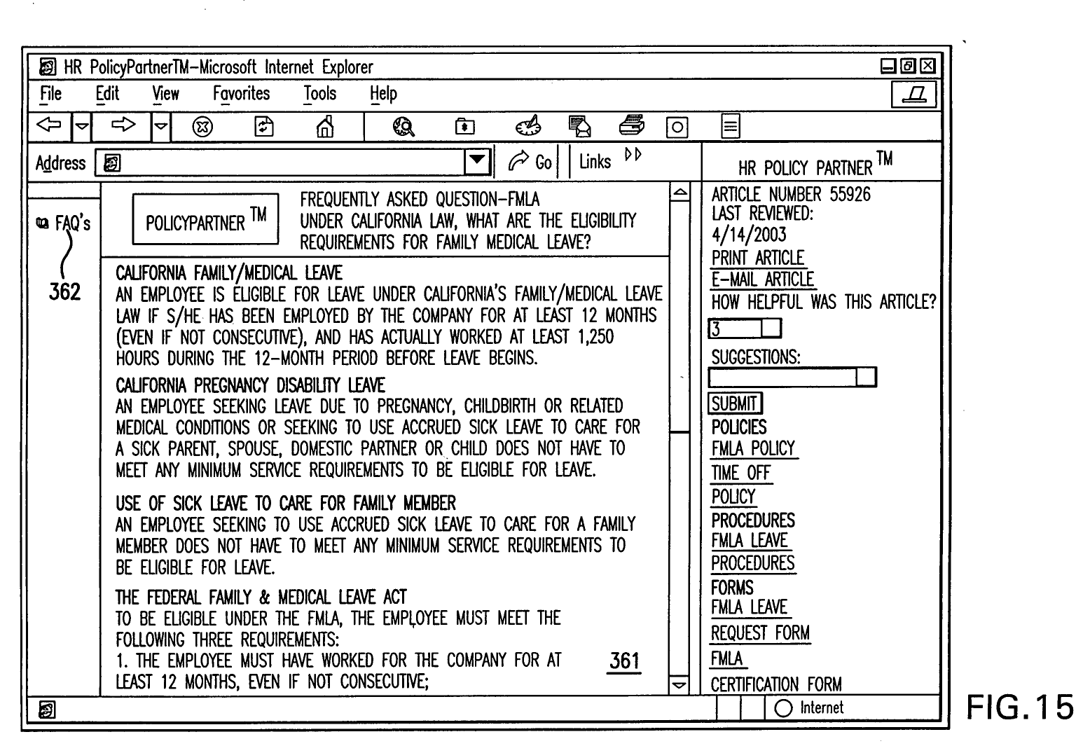

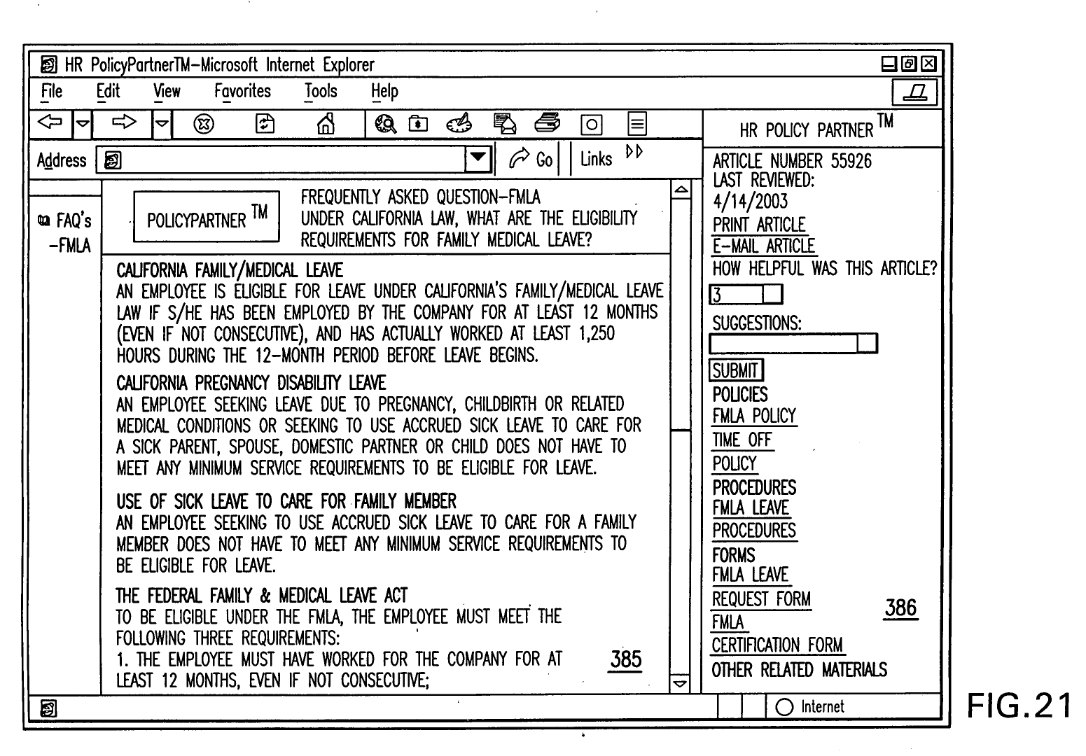

For example, referring now to FIG. 15, because the California-specific FMLA contains regulations that conflict with FMLA regulations, employers must provide their California employees with additional benefits, and must comply with more stringent requirements with respect to certain issues related to FMLA Leave. Page 361 therefore provides user access to the California-specific FMLA; the company policy is modified by the addition of the more stringent non-national law provision. For example, a user researching a subject employee in Pennsylvania, which does not have a state-specific FMLA, will see the standard company policy in interface portion 361 of FIG. 15. One particular benefit to this arrangement is that if a non-national law provision is amended or impacted by, for example, a statute or a court ruling, the uniform non-national law provision portion may be globally updated from a central source across all client pages in an instant. See also FIG. 21 highlighting that page 385 is not company-specific but that page 386 to the right of page 385 is. The contents of page 385 may therefore be updated from a master source.

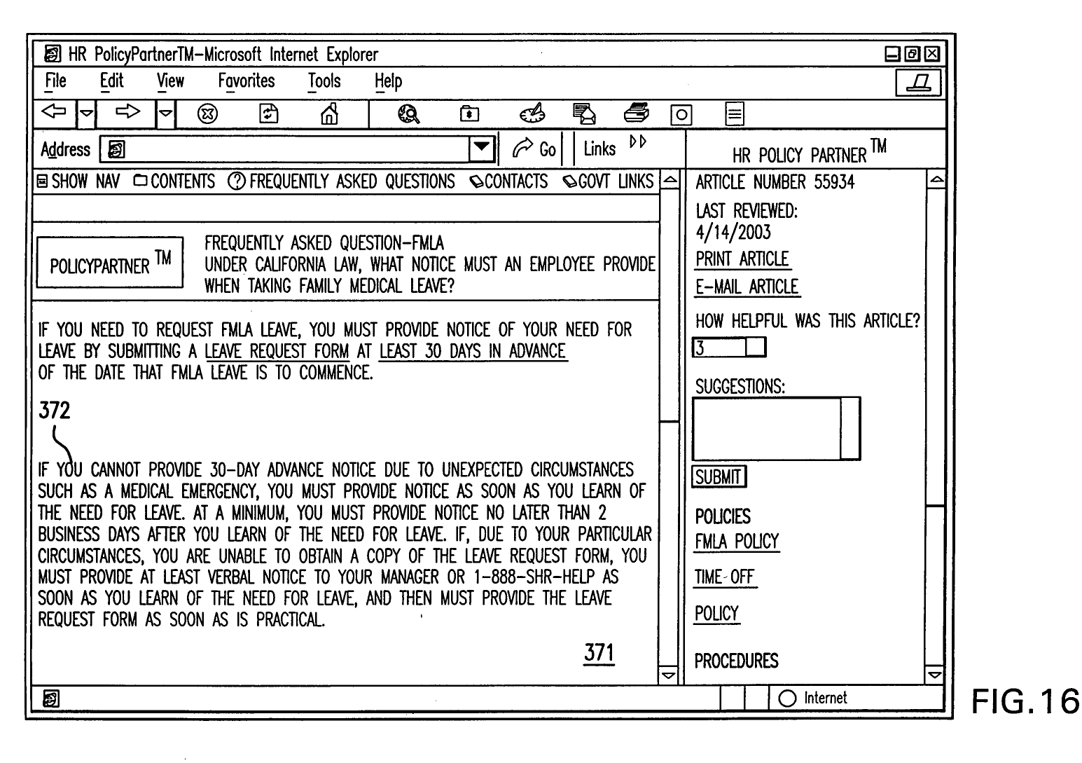

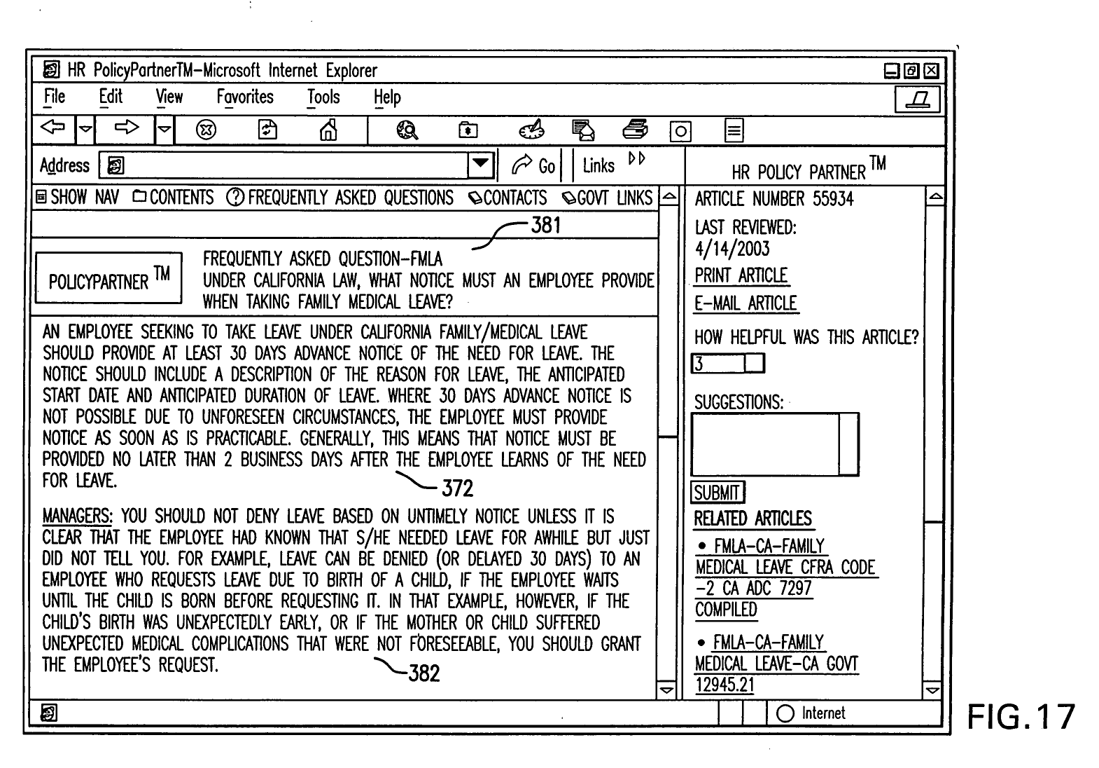

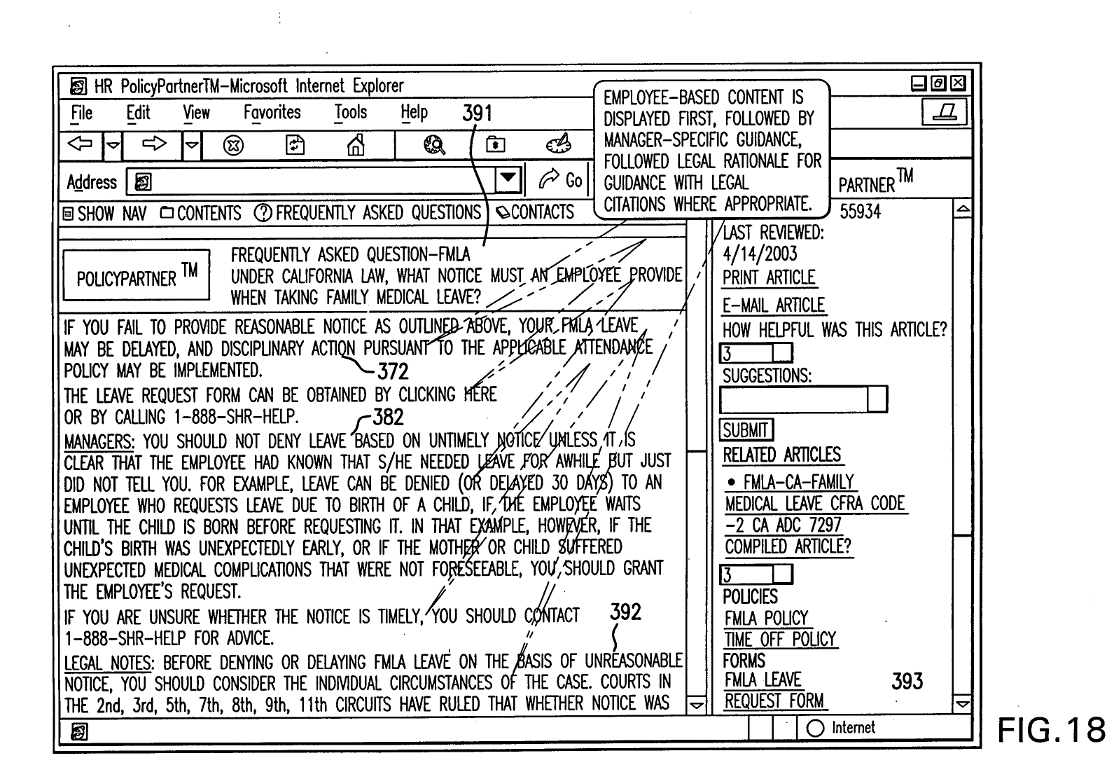

Referring back to FIG. 2, additional content is provided in addition to the policy provision and the non-national law provision included in page 361 of FIG. 15. For example, users may be provided access to Answers to FAQs 56 from FIG. 2. FIG. 15 includes access to FAQs 362. When selected, the system retrieves a list of FAQs from which the user may choose. After a particular FAQ is selected, a subject employee-appropriate FAQ response will be prominently displayed in page 371 in FIG. 16. The answer to the FAQ will vary depending on the user classification. For example, an answer to a rank-and-file employee is a straightforward narrative answer 372 alone as shown in FIG. 16. As shown in FIG. 17, the response provided a user with a user classification correlating to the job position of manager displays in page 381 the contents of page 372 plus additional information for managers, 382. Likewise, referring to FIG. 18, legal professionals are provided access to not only the information from pages 372 and 382 but also legal information 392 in page 391 which is specific to legal professionals.

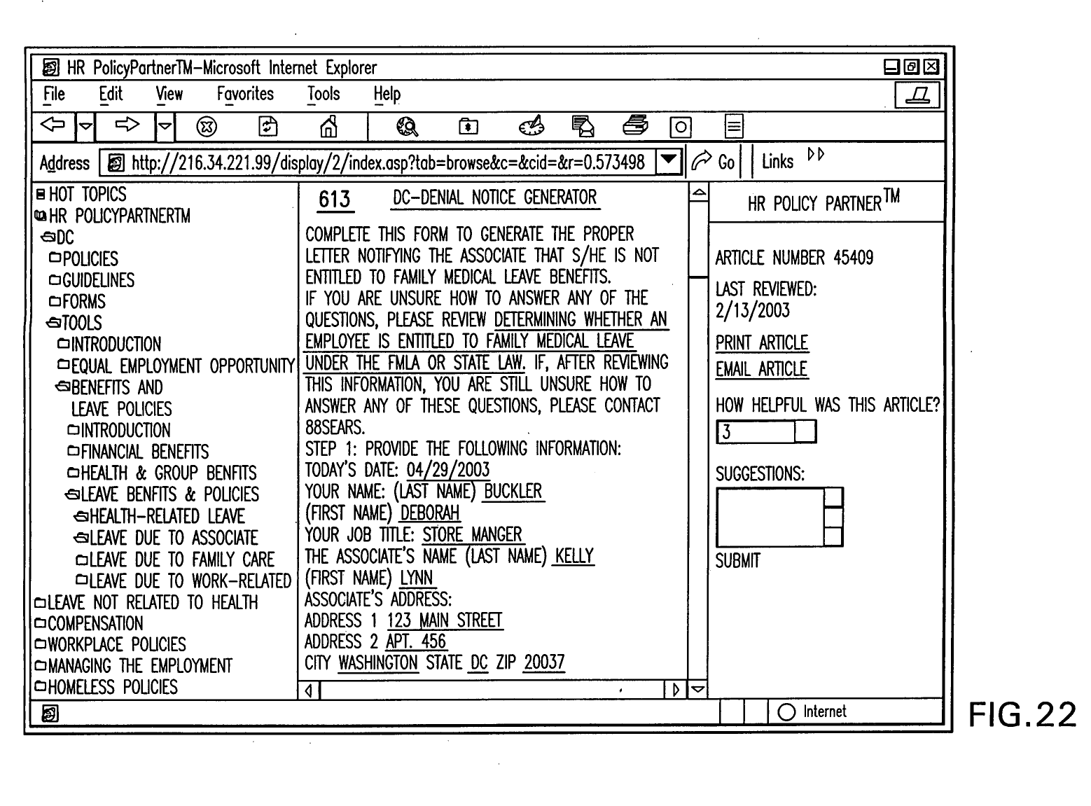

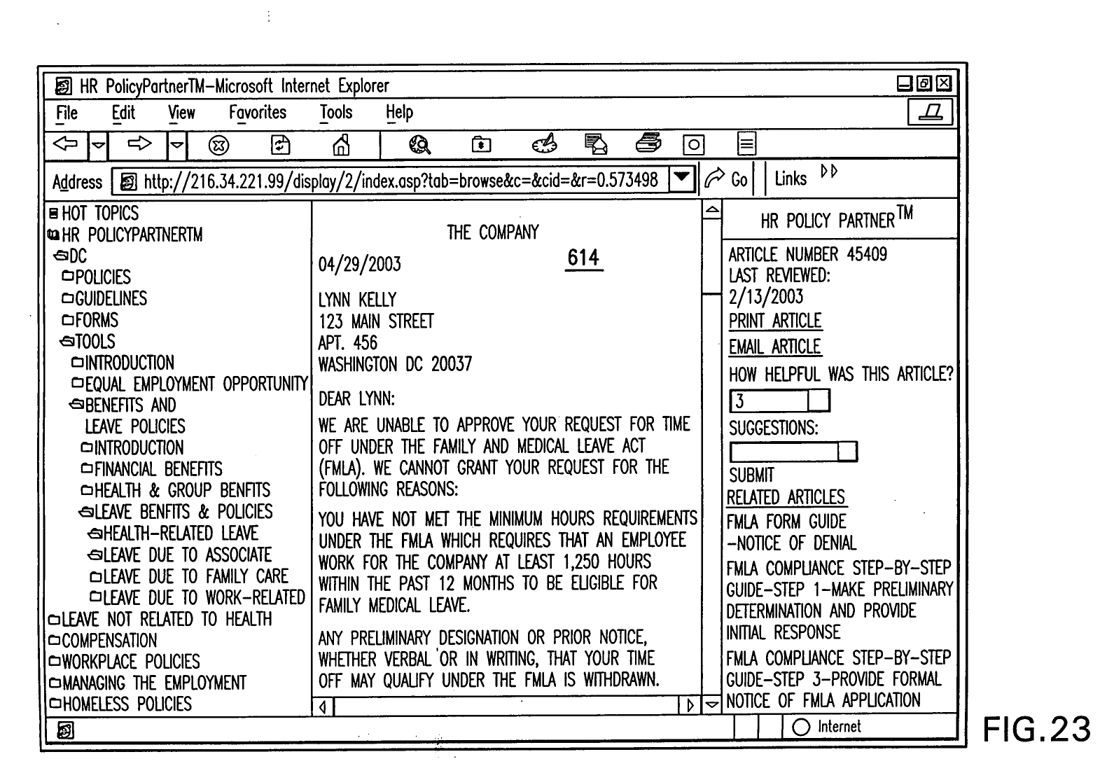

Referring still to FIG. 18, access to additional supplements 393 besides additional supplement FAQs page 391 is provided along the right hand side of page 391. As explained above, access to the FAQs page 391, other additional supplements 393 and indeed all additional supplements is based on user classification. Again, FIGS. 3-6 demonstrates the different types of additional supplements and to what user classifications they are available. Referring to FIG. 22 and FIG. 23, communication tools further examples of supplements to which a user is provided access based on user classification. FIG. 22 shows a denial notice generator 613 accessible to managers to refuse rank-and-file employees leave, but that is inaccessible to rank-and-file employees. FIG. 23 shows a final form letter 614 that may be generated from the denial notice generator. These examples are not intended to limit the materials that may be provided as additional supplements to the HR PolicyPartner™ system and other useful applications that can be provided as additional supplements will be clear to one of skill in the field.

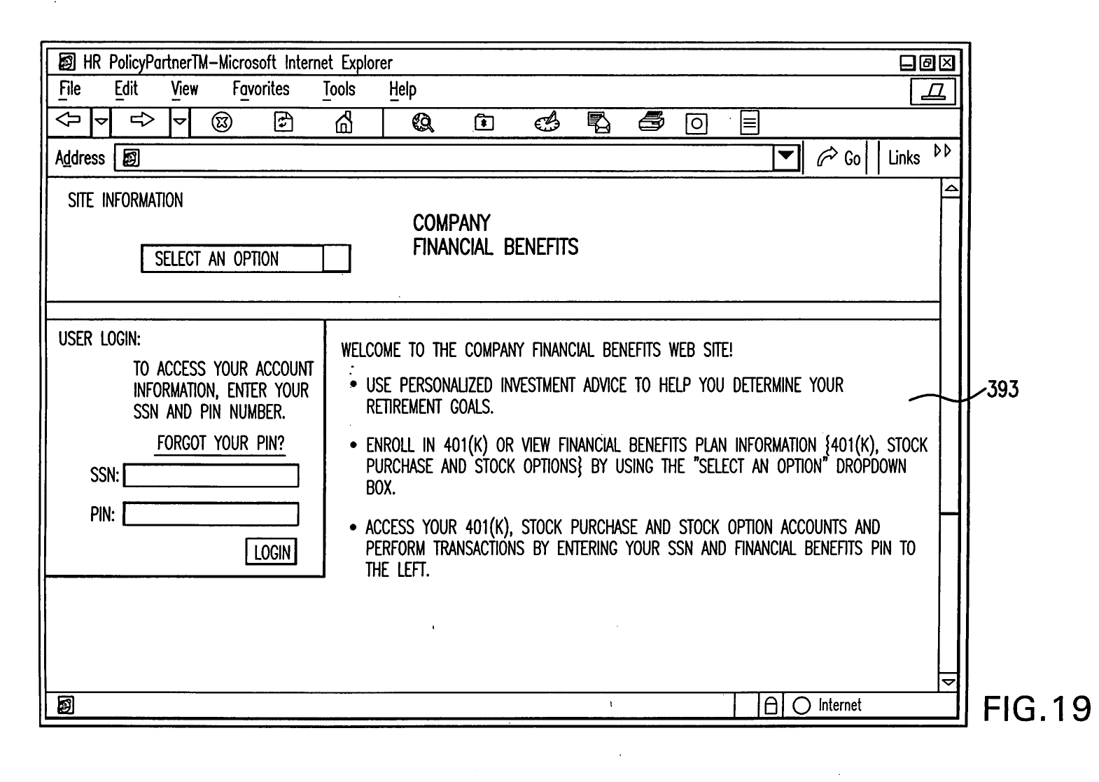

In addition to additional supplements, the system 700 may additionally provide access to users to other useful operational/transactional applications used by the company where the user is the subject employee. For example, referring to FIG. 19, the user/subject employee is provided access at page 393 to user's/subject employee's financial benefits records.

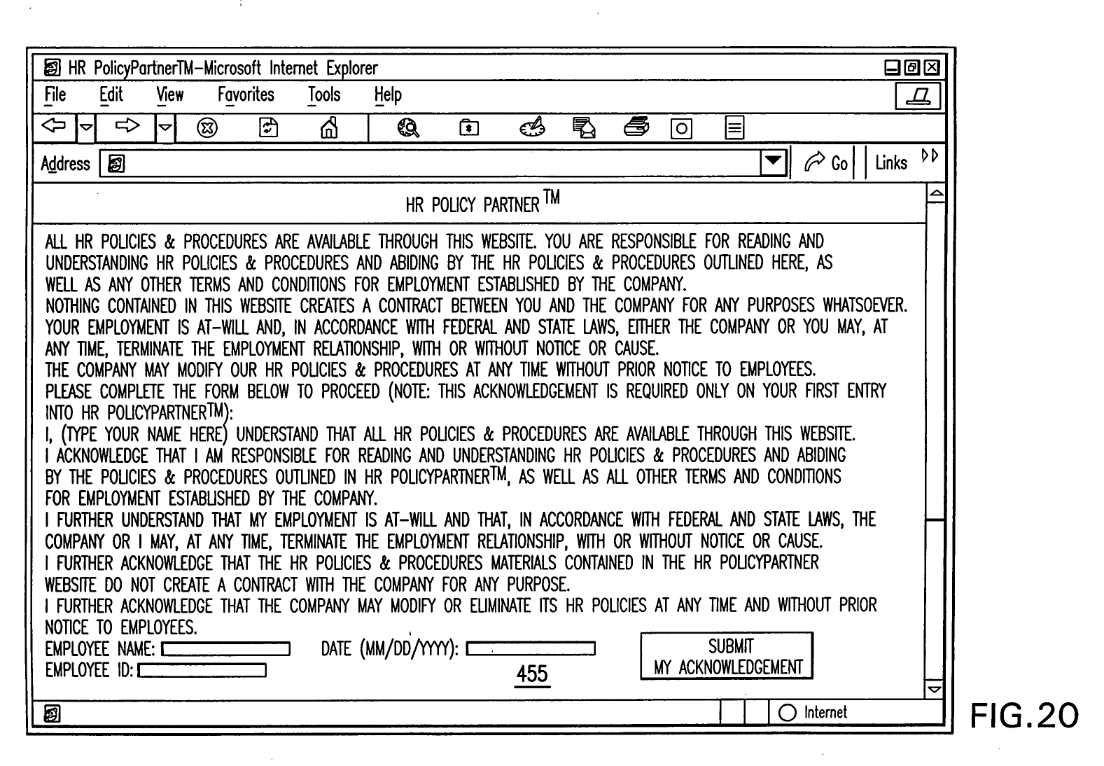

Most companies require employees to submit a written acknowledgment that s/he has received the company's HR policy documentation, and that s/he understands that company policy handbooks do not change the at-will employment status or create any form of employer-employee contract. As an additional feature, HR PolicyPartner enables companies to administer this requirement through the web. Referring now to FIG. 20, the first time an employee visits the HR PolicyPartner™ website, a notice/disclaimer is displayed at page 455. The employee must acknowledge that s/he has read and understood the disclaimer.

It should be readily understood that the present invention can be modified in the manners set forth herein as well as to any number of variations, alterations, substitutions or equivalent arrangements not heretofore described, but which are commensurate with the spirit and scope of the invention in order to obtain a desired memory functionality. Although reference is made to managing human resources policies in general, one skilled in the art should recognize that the claimed invention may be readily adapted for use in other highly regulated fields, and especially highly regulated fields that are governed to a large degree by non-national law. Examples of such fields include real estate and insurance law to name just two. Accordingly, the invention is not to be seen as limited by the foregoing description, but is only limited by the scope of the appended claims.

What is claimed as new and desired to be protected by Letters Patent of the United States is:

1. A method for administering a human resources policy comprising the steps of:
formulating a plurality of user classifications;
assigning at least one user one of said user classifications;
identifying at least one policy provision in said human resources policy;
identifying at least one non-national jurisdiction in which said policy provision is applied;
creating a file for said non-national jurisdiction;
including in said file said policy provision;
identifying at least one non-national law provision relating to said policy provision;
including in said file said non-national law provision;
identifying at least one additional supplement relating to said policy provision;
correlating each said additional supplement to at least one of said user classifications;
determining the user classification of an individual subsequent user;
providing said subsequent user access to each said additional supplement correlated to the user classification of said subsequent user.

2. The method of claim 1 wherein said user classification comprises classification based on said subsequent user's employment position.

3. The method of claim 1 further comprising the steps of:
receiving the non-national jurisdiction of employment of a subject employee;
limiting access of said subsequent user to said file for said non-national jurisdiction of employment of said subject employee.

4. The method of claim 3 wherein the step of receiving the non-national jurisdiction of employment comprises receiving a non-national jurisdiction from said subsequent user.

5. The method of claim 3 wherein the step of receiving the non-national jurisdiction of employment comprises the steps of:
receiving an employee identification of said subject employee from said subsequent user;
identifying a non-national jurisdiction of employment relating to said employee identification.

6. The method of claim 3 wherein said subject employee is said subsequent user.

7. The method of claim 1 further comprising the steps of:
monitoring said non-national law provision;
identifying amendments to said non-national law provision;
including in said file said amendments to said non-national law provision.

8. The method of claim 1 wherein said additional supplement is a national law provision.

9. The method of claim 1 where in said additional supplement is a legal citation.

10. The method of claim 1 wherein said additional supplement is a form to be completed by said subsequent user.

11. The method of claim 1 wherein said additional supplement is a set of guidelines.

12. The method of claim 1 wherein said additional supplement is a set of procedures.

13. The method of claim 1 wherein said additional supplement is an article.

14. The method of claim 1 wherein said additional supplement is at least one frequently asked question.

15. The method of claim 1 further comprising the steps of:
monitoring said additional supplement;
identifying amendments to said additional supplement;
including in said file said amendments to said additional supplement.

16. A system for administering a human resources policy comprising:
a processor;
memory operationally attached to said processor;
an input device operationally attached to said processor;
storing means for storing:
a plurality of user classifications;
at least one policy provision from the policy;
at least one non-national law provision relating to said policy provision;
at least one additional supplement relating to said policy provision and correlated to at least one of said user classifications;
determining means for determining the user classification of an individual subsequent user;
retrieval means for retrieving, based on said user classification of said subsequent user, said policy provision, said non-national law provision, and said at least one correlated additional supplement.
delivery means for delivering said retrieved policy provision, said retrieved non-national law provision, and retrieved said at least one correlated additional supplement.

17. The system of claim 16 wherein said user classification comprises classification based on said subsequent user's employment position.

18. The system of claim 16 further comprising:
receiving means for receiving the non-national jurisdiction of employment of a subject employee;
limiting means for limiting access of said subsequent user to said retrieved policy provision, said retrieved non-national law provision, and retrieved said at least one correlated additional supplement for said non-national jurisdiction of employment of said subject employee.

19. The system of claim 18 wherein said receiving means receives said non-national jurisdiction of employment by receiving a non-national jurisdiction from said subsequent user.

20. The system of claim 18 wherein said receiving means receives said non-national jurisdiction of employment by:
receiving an employee identification of said subject employee from said subsequent user; and
identifying a non-national jurisdiction of employment relating to said employee identification.

21. The system of claim 18 wherein said subject employee is said subsequent user.

22. The system of claim 16 further comprising updating means for updating said non-national law provision.

23. The system of claim 22 wherein said updating means further comprises:
monitoring means for monitoring said non-national law provision;
identifying means for identifying amendments to said non-national law provision; and
amending means for amending said non-national law provision stored in said storing means.

24. The system of claim 16 further comprising updating means for updating said at least one additional supplement relating to said policy provision.

25. The system of claim 24 wherein said updating means further comprises:
identifying means for identifying a new additional supplement relating to said policy provision; and
including means for including said new additional supplement relating to said policy provision with said at least one additional supplement relating to said policy provision.

26. The system of claim 16 wherein said additional supplement is a national law provision.

27. The system of claim 16 where in said additional supplement is a legal citation.

28. The system of claim 16 wherein said additional supplement is a form to be completed by said subsequent user.

29. The system of claim 16 wherein said additional supplement is a set of guidelines.

30. The system of claim 16 wherein said additional supplement is a set of procedures.

31. The system of claim 16 wherein said additional supplement is an article.

32. The system of claim 16 wherein said additional supplement is at least one frequently asked question.

33. A system for administering a plurality of policies comprising:
a processor;
memory operationally attached to said processor;
an input device operationally attached to said processor;
storing means for storing:
a plurality of user classifications;
a plurality of policies each relating to a separate business unit and each comprising at least one policy provision;
at least one non-national law provision relating to said policy provision;
at least one additional supplement relating to said policy provision and correlated to at least one of said user classifications;
determining means for determining the user classification of an individual subsequent user;
receiving means for receiving the business unit of employment of a subject employee;
retrieval means for retrieving, based on said user classification of said subsequent user and said business unit of said subject employee, said policy provision, said non-national law provision, and said at least one correlated additional supplement.
delivery means for delivering said retrieved policy provision, said retrieved non-national law provision, and retrieved said at least one correlated additional supplement.
